(19) United States
(12) Patent Application Publication
(10) Pub. No.: US 2026/0058055 A1
(43) Pub. Date: Feb. 26, 2026

(54) System-On-Chip With A Plurality Of Chips Communicating Wirelessly Using Horizontal Inductive Coupling

(71) Applicant: THE UNIVERSITY OF TOKYO, Tokyo (JP)

(72) Inventors: Hidetsugu IRIE, Tokyo (JP); Junichiro Kadomoto, Tokyo (JP); Shuichi Sakai, Tokyo (JP)

(21) Appl. No.: 19/181,599

(22) Filed: Apr. 17, 2025

Related U.S. Application Data
(63) Continuation of application No. 17/778,091, now Pat. No. 12,300,427.

(30) Foreign Application Priority Data
Nov. 26, 2019 (JP) 2019-212966

(51) Int. Cl. H01F 38/14; G06F 15/78

(52) U.S. Cl. CPC H01F 38/14; G06F 15/7807; H01F 2038/143

(57) ABSTRACT

An information processing device is provided that can more flexibly adapt to changes in shape and mounting configuration. The information processing device has a plurality of chips that are integrated in the horizontal direction. A transmission coil and reception coil pair is formed in each of the plurality of chips, and each of the plurality of chips uses horizontal inductive coupling to achieve wireless connection between the chips.

### CROSS REFERENCE TO RELATED APPLICATIONS

This application is a continuation of U.S. patent application No. 17/778,091 filed May 19, 2022, which is based on U.S. National Phase Application under 35 U.S. C. 371 of International Application No. PCT/JP2020/043363, filed on Nov. 20, 2020, which claims priority to Japanese Patent Application No. 2019-212966, filed on Nov. 26, 2019. The entire disclosures of the above applications are expressly incorporated by reference herein.

### BACKGROUND

### Technical Field

The present invention relates to an information processing apparatus.

### Related Art

A Soc (System-on-a-Chip) in which different blocks are mixedly mounted on a single chip is known.

FIG. 2 in Patent Application Publication No. 2019-191920 discloses a processor Soc.

However, the conventional Soc has a problem that mounting shape and shape variation are limited.

The present invention has been made in view of the above circumstances and provided an information processing apparatus capable of flexibly responding to mounting shape and shape variation.

### SUMMARY

According to one aspect of the present invention, provided is an information processing apparatus comprising a plurality of chips, wherein the plurality of chips are horizontally integrated, a pair of transmitting coil and receiving coil are formed on each of the plurality of chips, and each of the plurality of chips communicate each other via a wireless connection using horizontal inductive coupling.

### Advantageous Effect of the Invention

According to one aspect of the present invention, it is possible to provide an information processing apparatus capable of flexibly responding to mounting shape and shape variation.

### BRIEF DESCRIPTION OF THE DRAWINGS

FIG. 1 is a diagram (part 1) showing an example of chip-to-chip wireless bus in horizontal direction.

FIG. 2 is a diagram (part 2) showing an example of chip-to-chip wireless bus in horizontal direction.

FIG. 3 is a diagram (part 3) showing an example of chip-to-chip wireless bus in horizontal direction.

FIG. 4 is a diagram showing an example when combined with a wireless electric power supply technology.

FIG. 5 is a diagram (part 1) for illustrating horizontal inductive coupling between coils.

FIG. 6 is a diagram (part 2) for illustrating horizontal inductive coupling between coils.

FIG. 7 is a diagram showing an example of a transmitting/receiving core circuit.

FIG. 8 is a diagram showing an example of an operation waveform in a transmitting/receiving core circuit.

FIG. 9 is a diagram showing an example of a transmitting/receiving circuit configured on a chip.

FIG. 10 is a diagram showing an example of a transmitting coil and a receiving coil.

FIG. 11 is a diagram showing an example of an electromagnetic field simulation environment.

FIG. 12 is a diagram showing an example of mutual inductance of vertically long rectangular coils.

FIG. 13 is a diagram showing an example of mutual inductance of horizontally long rectangular coils.

FIG. 14 is a diagram showing a simulation result when a relative angle between coils changes.

FIG. 15 is a diagram for illustrating a coil diameter and a communication distance.

FIG. 16 is a diagram showing an example of a simulation waveform of a transmitting/receiving core circuit.

FIG. 17 is a diagram showing a relationship between a coil diameter and a maximum transfer rate.

FIG. 18 is a diagram showing a performance comparison between a conventional wired communication technology and a wireless bus technology.

FIG. 19 is a diagram showing influence of ring-shaped wiring.

FIG. 20 is a diagram showing influence of a power ring.

FIG. 21 is a diagram showing influence of a seal ring.

FIG. 22 is a diagram showing an example of a prototype substrate.

FIG. 23 is a diagram showing an example of a measured eye pattern and bathtub curve.

FIG. 24 is a diagram showing an example of an electromagnetic field simulation environment.

FIG. 25 is a diagram showing a relationship between a communication distance and a coupling coefficient.

FIG. 26 is a diagram showing a relationship between a coil misalignment and a coupling coefficient.

FIG. 27 is a diagram showing a coupling coefficient when a plurality of coils are arranged.

FIG. 28 is a diagram for illustrating a communication distance.

FIG. 29 is a diagram showing an example of a simulation waveform of a transmitting/receiving core circuit.

FIG. 30 is a diagram showing an example of a measured eye pattern and bathtub curve.

### DETAILED DESCRIPTION

Hereinafter, embodiments of the present invention will be described with reference to the drawings. Various features described in the embodiment below can be combined with each other.

In the present embodiment, the “unit” may include, for instance, a combination of hardware resources implemented by circuits in a broad sense and information processing of software that can be concretely realized by these hardware resources. Further, various information is performed in the present embodiment, and these information can be represented by high and low signal values as a bit set of binary numbers composed of 0 or 1, and communication/calculation can be performed on a circuit in a broad sense.

Further, the circuit in a broad sense is a circuit realized by combining at least an appropriate number of a circuit, a circuitry, a processor, a memory, and the like. In other words, it is a circuit includes Application Specific Integrated Circuit (ASIC), Programmable Logic Device (e.g., Simple Programmable Logic Device (SPLD), Complex Programmable Logic Device (CPLD), and Field Programmable Gate Array (FPGA)), and the like.

### Embodiment 1

1. Horizontal Chip-to-chip Wireless Bus

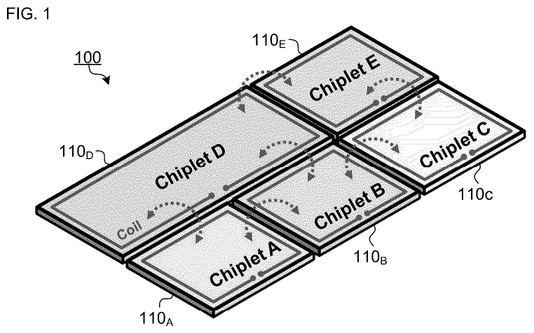

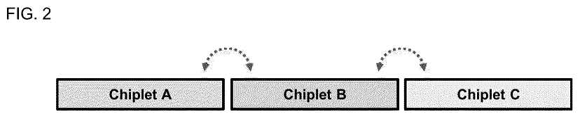

FIG. 1 is a diagram (part 1) showing an example of chip-to-chip wireless bus in a horizontal direction. Further, FIG. 2 is a diagram (part 2) showing an example of chip-to-chip wireless bus in a horizontal direction. An information processing apparatus 100 comprises a plurality of chips 110_{A}to 110_{E}. The plurality of chips 110_{A} to 110_{E} are horizontally integrated. A pair of transmitting coil and receiving coil are formed on each of the plurality of chips. Each of the plurality of chips 110_{A} to 110_{E} communicate each other via a wireless connection using horizontal inductive coupling.

As shown in FIG. 1, an on-chip coil is formed using an internal wiring of the chip. In addition, as shown in FIGS. 1 and 2, the chips communicate each other via a wireless connection using horizontal inductive coupling.

With such a configuration, there is no need to set up and manufacture a silicon interposer, and the information processing apparatus 100 can be constructed at low cost by flexibly combining chiplets.

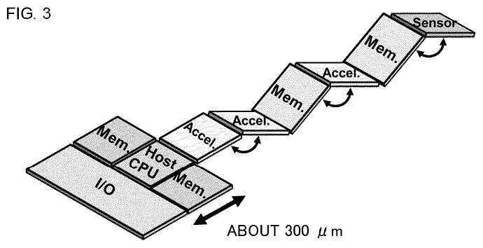

FIG. 3 is a diagram (part 3) showing an example of chip-to-chip wireless bus in a horizontal direction. As shown in FIG. 3, the information processing apparatus 100 can be implemented in any shape. For instance, it is possible to implement a series of long slender chips like a fiber itself, a mounting in which a relative angle between the chips is slanted, and a system in which the shape is deformed during operation. One of the plurality of chips configuring the information processing apparatus 100 is a CPU (Central Processing Unit). Further, one of the plurality of chips configuring the information processing apparatus 100 is a memory. The information processing apparatus 100 is not limited thereto. Hardware configuring the information processing apparatus 100 may be configured of one or more chips. For instance, a CPU may be configured by at least two or more of the plurality of chips configuring the information processing apparatus 100. That is, the chips configuring the information processing apparatus 100 can be flexibly separated.

The information processing apparatus 100 does not necessarily have to comprise a CPU and a memory.

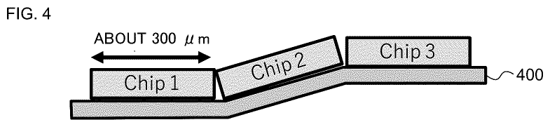

FIG. 4 is a diagram showing an example when combined with a wireless electric power supply technology.

In the information processing apparatus 100, the chips can be implemented on a diverse substrate 400 by combining horizontal chip-to-chip wireless bus and wireless power supply technology. Further, the chips can be easily replaced even after implementation. As shown in FIG. 4, a plurality of chips are horizontally integrated on the substrate 400. Here, the substrate 400 is a variable shape member. The variable shape member is a member that can be deformed in shape, for example, flexible substrate, plastic, fiber, or the like. The information processing apparatus 100 can be constructed simply by fixing and arranging chips on such a variable shape member with something such as DAF tape, and in the event of a failure or System updater, a new information processing apparatus 100 can be realized in which the chips need only be replaced and rearranged.

### 2. Horizontal Inductive Coupling Between Coils

First, horizontal inductive coupling between on-chip coils will be illustrated. Degree of coupling between coils is mainly determined by length and distance of one adjacent side of two coils. Therefore, as the coil is larger and the distance between adjacent sides is shorter, the coupling becomes stronger. Through such an inductive coupling, a signal can be transmitted from the transmitting coil to the receiving coil.

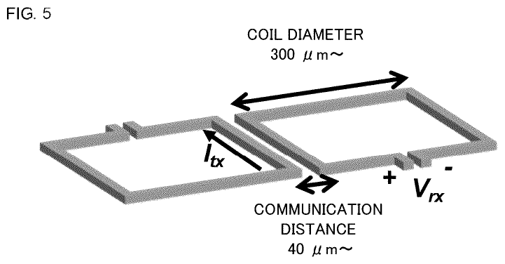

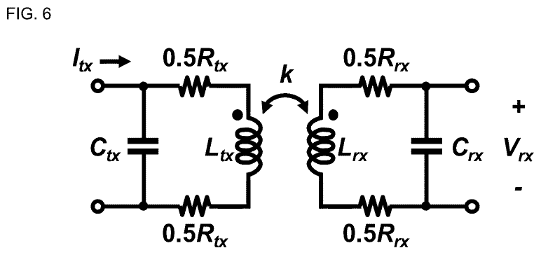

For instance, as shown in FIG. 5, when a transmitting current Itx flows toward a back side of a screen, a corresponding receiving voltage Vrx is induced on a receiving side. Characteristics of this coil can be represented by an equivalent circuit shown in FIG. 6. The receiving voltage is obtained by multiplying a first-order differential waveform of the transmitting current Itx with a second-order low-pass filter characteristics on the transmitting side and the receiving side. Further, amplitude of the receiving voltage Vrx is proportional to the transmitting current and a coupling coefficient. Assuming that a threshold value for normally restoring data on the receiving side is constant, it is necessary to flow a double current when the coupling coefficient is halved, which determines power consumption of a transmitting circuit.

### 3. Transmitting/receiving Core Circuit

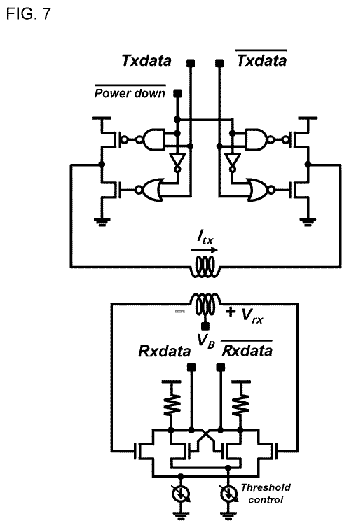

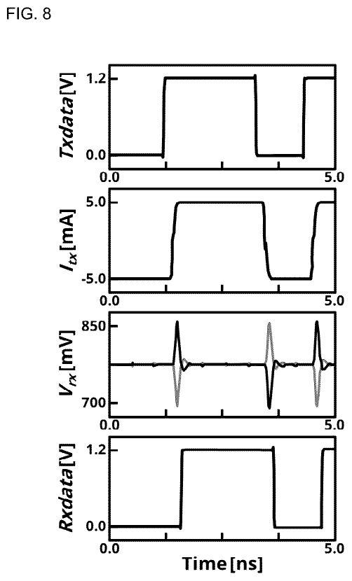

Subsequently, a transmitting/receiving core circuit will be described with reference to FIGS. 7 and 8. FIGS. 7 and 8 are diagrams for illustrating the transmitting/receiving core circuit configured on the chip. Here, the coil is driven by two inverters. The transmitting current Itx in a direction corresponding to input Txdata flows into the coil, resulting in a pulse voltage corresponding to data transition is generated on a receiving side as shown in FIG. 8. At this time, polarity of pulse differs depending on whether the data transition is from LOW to HIGH or from HIGH to LOW. A hysteresis comparator on the receiving side restores the pulse voltage to original NRZ data, and final Rxdata is obtained as shown in FIG. 8.

### 4. Transmitting/Receiving Circuit

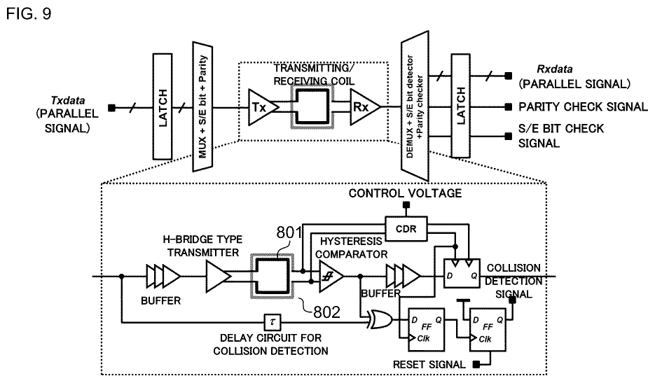

FIG. 9 is a diagram showing an example of a transmitting/receiving circuit configured on a chip. A method of serializing and burst transferring a parallel signal sent from a core is adopted. As shown in FIG. 9, a SerDes (SERializer/DESerializer) for connection to a digital circuit and a CDR circuit are mounted in the transmitting/receiving circuit. Further, the transmitting/receiving circuit is also mounted with a collision detection circuit. When a collision of transmitting data occurs between chips, the collision detection circuit retransmits data according to a procedure defined by an upper protocol. A transmitting coil 801 is a transmitter coil. A receiving coil 802 is a receiving coil.

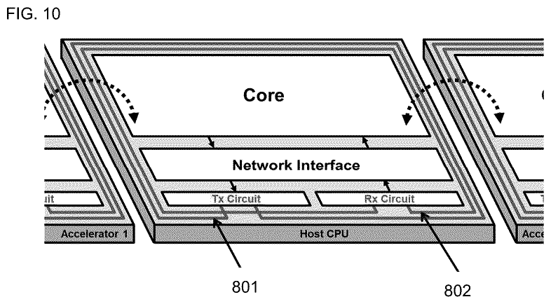

FIG. 10 is a diagram showing an example of the transmitting coil 801 and the receiving coil 802. In the present embodiment, since a large coil of several mm square is utilized, area of entire interface becomes extremely large. However, since influence of a magnetic field generated by an on-chip coil on an internal circuit is small, as shown in FIG. 10, a coil is formed along a peripheral portion where wiring resources are more abundant than inside of the core, and a core circuit, a network interface, or a transmitting/receiving circuit can be formed inside thereof. Considering communication characteristics and design example of a typical square chip, each side of the transmitting coil 801 and the receiving coil 802 has a length of at least about 90% with respect to each side of the chip. An opening area of the transmitting coil and an opening area of the receiving coil should be 80% or more of an area of the chip.

The transmitting coil 801 and the receiving coil 802 may be formed on different layers of the chip. Further, the transmitting coil 801 and the receiving coil 802 may be formed at substantially same position on each of the plurality of chips.

### 5. Electromagnetic Field Simulation Environment

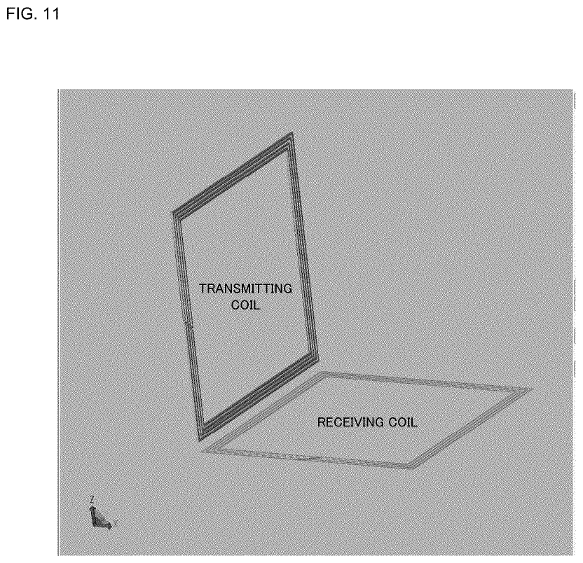

FIG. 11 is a diagram showing an example of an electromagnetic field simulation environment. A simulation model of a coil and a substrate are created based on parameters of a manufacturing process, and a coupling coefficient between coils is investigated by using EmPro, which is a three-dimensional electromagnetic field simulator of Keysight Technologies. S parameter obtained by the electromagnetic field simulation is fitted to an equivalent circuit, and a coupling coefficient and mutual inductance obtained from the result are adopted as a simulation result.

### 6. Mutual Inductance of Rectangular Coils

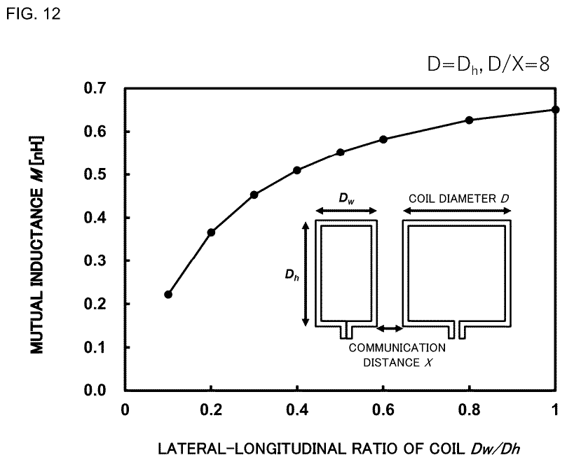

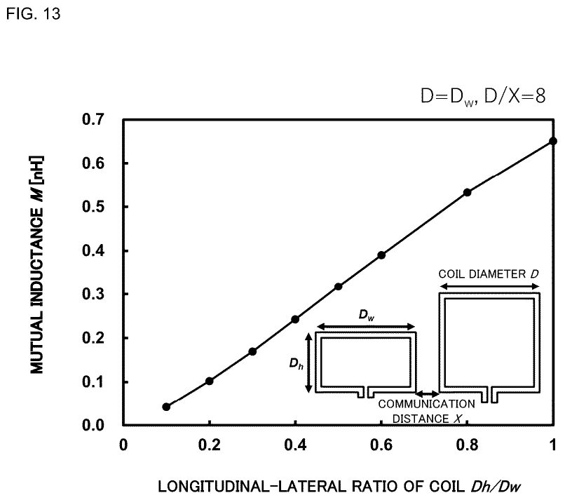

FIGS. 12 and 13 are diagrams showing examples of mutual inductance of rectangular coils. FIG. 12 shows a change in a mutual inductance when a side Dw, which is orthogonal to a side closest to an adjacent coil of the transmitting coil, is shortened. As can be seen from a result, even when Dw is halved, the mutual inductance is 85% as compared with a case of a square, and the mutual inductance decreases relatively slowly.

On the other hand, FIG. 13 shows a change in a mutual inductance when a side closest to an adjacent coil is shortened. The mutual inductance decreases linearly as the side becomes shorter, and when the side is halved, the mutual inductance is 49% as compared with the case of the square.

From the results, it was clarified that the coils are coupled even in the rectangular case and that the mutual inductance changes according to the shape. Since the side closest to the adjacent coil contributes strongly to coupling, the mutual inductance decreases linearly when the side becomes shorter. For example, when the mutual inductance is kept at a value of 90% or more based on the case of a square coil, the side (Dw) orthogonal to the side closest to the adjacent coil needs to be 60% or longer, and the side (Dh) closest to the adjacent coil needs to be 90% or longer.

7. Relationship between Relative Angle and Coupling Coefficient

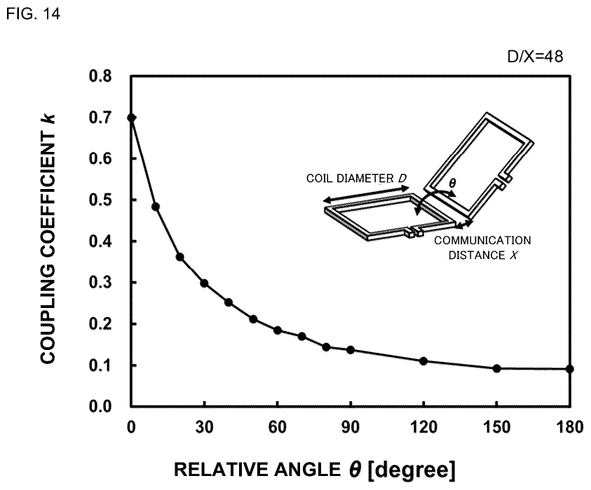

FIG. 14 is a diagram showing a simulation result when a relative angle between coils changes. As shown in FIG. 14, it was confirmed by a simulation the coupling coefficient monotonically increases as the relative angle decreases when the coils are oblique to each other.

From the result, it was found that although the oblique coils also couple with each other, the coupling coefficient changes according to the relative angle. Here, considering a hysteresis comparator of the receiving circuit, an input voltage thereof is required to be in a range that is equal to or higher than a threshold value of a comparator and does not exceed a supply voltage. For example, if an amplitude for a relative angle of 180 degrees, which is the lowest signal amplitude, is 100 mV, then a received signal amplitude at a relative angle of 0 degree would be 760 mV. Assuming a process with a core supply voltage of about 1 V, it is considered as a typical design example that a maximum voltage amplitude does not exceed the supply voltage, and at a minimum, a sufficient amplitude that is not buried in the noise floor can be secured.

### 8. Circuit Simulation

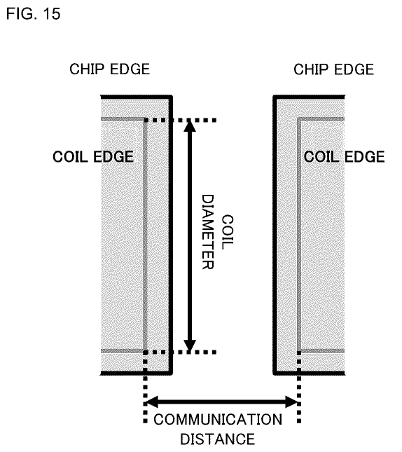

By circuit simulation, performance of the transmitting/receiving circuit and influence of ring-shaped wiring on communication characteristics are investigated. A 45nm CMOS process was assumed as a manufacturing process, and a coil diameter is investigated in a range of 100 μm to 5 mm in a square. At this time, a communication distance is set to a value of 1/10 of the coil diameter. FIG. 15 is a diagram for illustrating a coil diameter and a communication distance.

For parts of coil and ring-shaped wiring, a model is created from the result of the electromagnetic field simulation, which is then included in the circuit simulation.

### 9. Simulation Waveform of Transmitting/Receiving Core Circuit

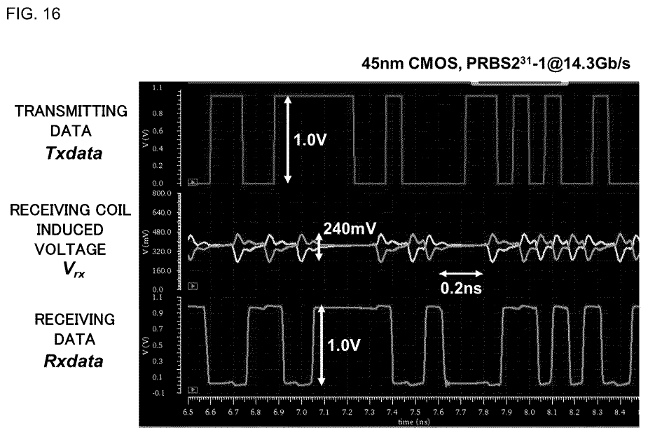

FIG. 16 is a diagram showing an example of a simulation waveform of a transmitting/receiving core circuit. Under a condition of a coil diameter of 300 μm, transfer of PRBS 31 signal is simulated, and a maximum transfer rate of 14.3 Gb/s and power consumption of 7.91 mW are achieved.

10. Relationship between Coil Diameter and Maximum Transfer Rate

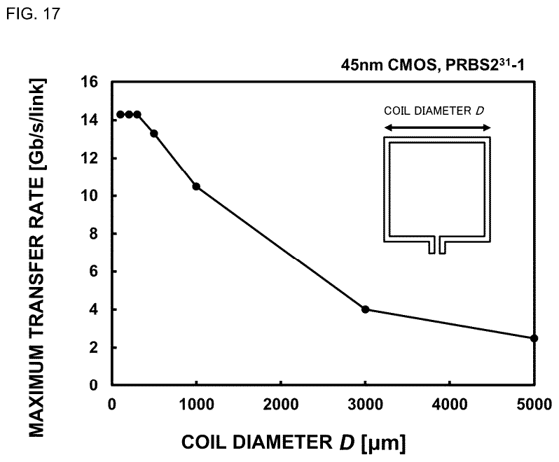

FIG. 17 is a diagram showing a relationship between a coil diameter and a maximum transfer rate. As the coil diameter decreases, a parasitic capacitance decreases, thus the maximum transfer rate improves. In a process of the present embodiment, since a transmission rate is limited by the transmitting/receiving circuit, a transfer rate is not improved for a coil of 300 μm or less, but further performance improvement can be expected when an advanced process is used. In other words, performance of wireless bus technology can be expected to improve by development of process miniaturization, finer granularity of each chiplet, and mounting technology.

### 11. Performance Comparison

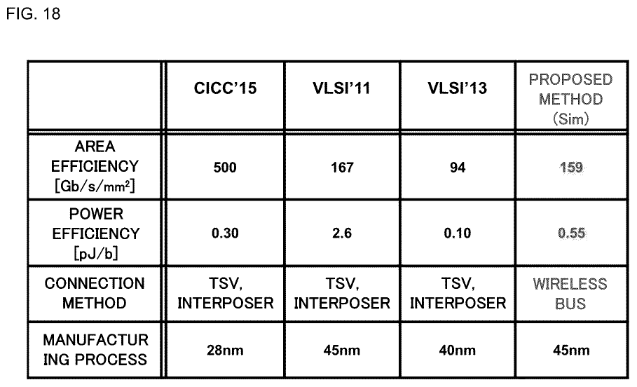

FIG. 18 is a diagram showing a performance comparison between a conventional wired communication technology and a wireless bus technology. Three on left are all high-speed communication technologies using silicon interposer. With the wireless bus technology, a result comparable to the wired communication technology using the silicon interposer in terms of data transfer efficiency per interface area and power efficiency can be obtained.

### 12. Influence of Ring-Shaped Wiring

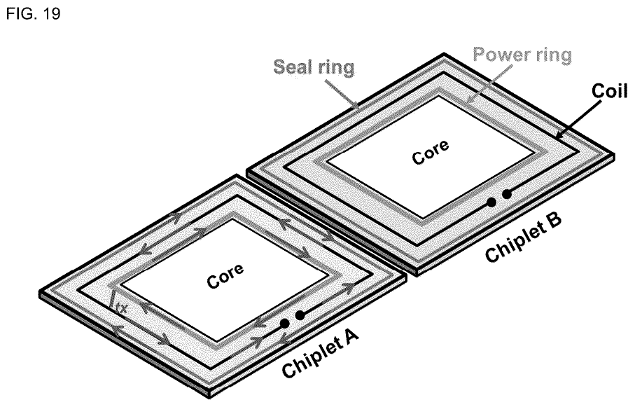

FIG. 19 is a diagram showing influence of ring-shaped wiring. As shown in FIG. 19, when a ring-shaped wiring of the same size as the coil exists on the chip, eddy current in an opposite direction flow through these ring-shaped wirings when the transmitting current flows, which may adversely affect communication characteristics. Examples of such ring-shaped wiring include a power ring for power distribution and a seal ring for chip protection.

### 13. Influence of Power Ring

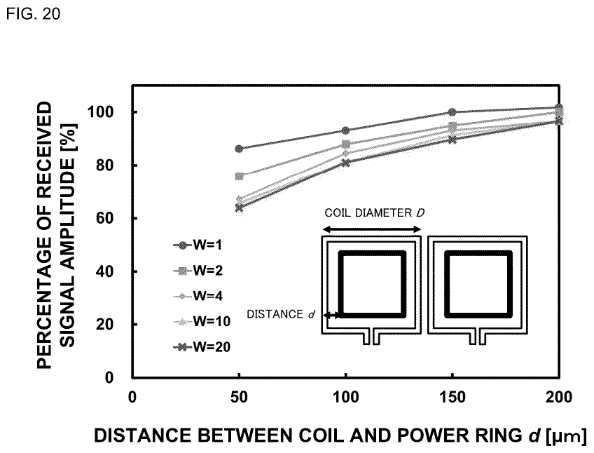

FIG. 20 is a diagram showing influence of a power ring. When a power ring is present on the chip, a received signal amplitude decreases due to influence of eddy current. Such influence can be mitigated to some extent by making the power ring thinner and by increasing distance between the coil and the power ring. For example, in order to obtain an amplitude of about 80% when the thickness of the power ring is 20 μm and the ring does not exist, a distance d from the ring needs to be 150 μm or more when the coil diameter is 1 mm.

### 14. Effect of Seal Ring

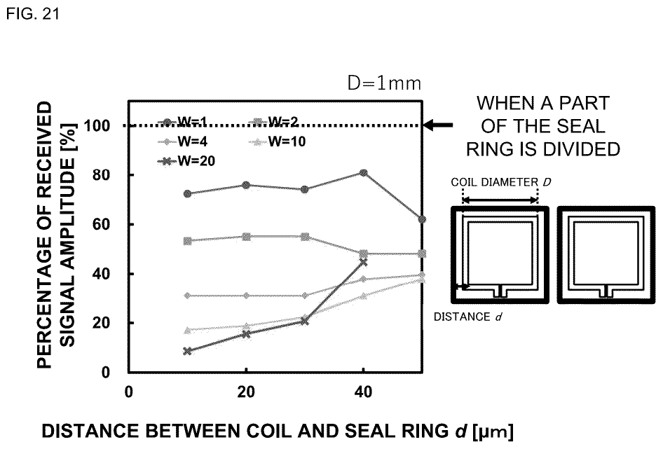

FIG. 21 is a diagram showing influence of a seal ring. Even if there is a seal ring on the chip, the received signal amplitude decreases due to influence of eddy current. Such influence can be mitigated to some extent by making the seal ring thinner. For example, in order to obtain an amplitude of about 50% when the ring does not exist, thickness of the seal ring needs to be 2 um or less. On the other hand, even when a part of the seal ring is cut off, if length of the cut-off part is short enough, it can function as a seal ring and can prevent moisture penetration and crack propagation without problems. Simulation using a partially cut seal ring shows no influence on the received signal amplitude. Therefore, if possible in the process, using a divided seal ring may be considered as an option.

### 15. Prototype Substrate

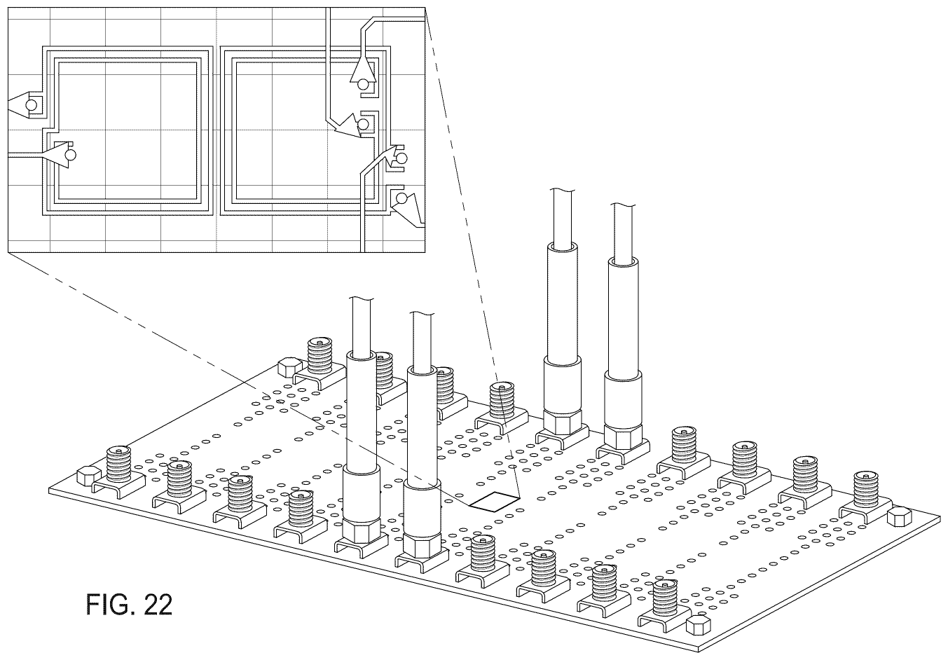

FIG. 22 is a diagram showing an example of a prototype substrate. In order to evaluate the wireless bus technology through an actual measurement, a prototype substrate is designed, prototyped, and measured. A high-speed hysteresis comparator IC is used as receiving circuit, and a pulse waveform transmitted via the coil is restored to an NRZ waveform.

### 16. Measurement Result

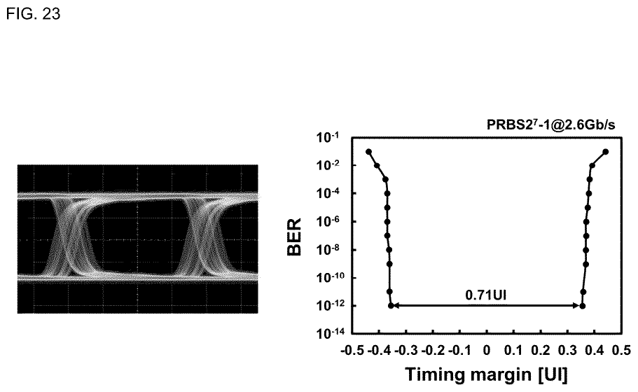

FIG. 23 is a diagram showing an example of a measured eye pattern and bathtub curve. When PRBS7 signal is applied, a maximum transfer rate of 2.6 Gbps is achieved under a condition that BER is 10-12 or less. At that time, a sufficiently wide result is obtained with a timing margin of 0.71 UI.

### 17. Effect of Embodiment 1

According to embodiment 1, an information processing apparatus capable of flexibly responding to mounting shape and shape variation can be provided.

### Modification 1

### 1. Electromagnetic Field Simulation Environment

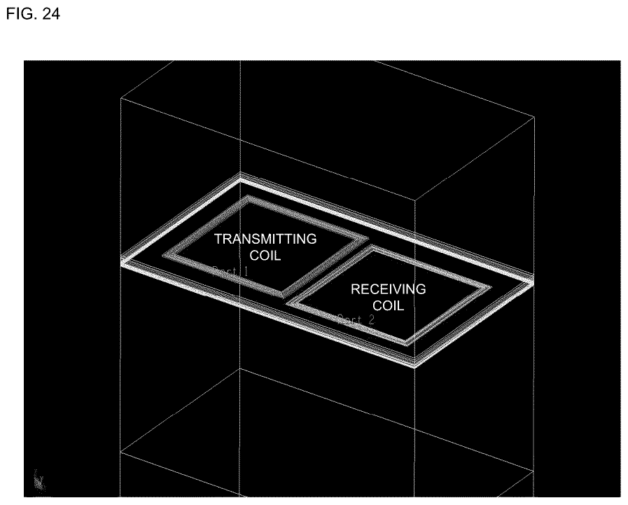

FIG. 24 is a diagram showing an example of an electromagnetic field simulation environment. A simulation model of a coil and a substrate is created based on parameter of a manufacturing process, and a coupling coefficient between coils is investigated by using Momentum, which is a three-dimensional electromagnetic field simulator of Keysight Technologies.

2. Relationship between Communication Distance and Coupling Coefficient

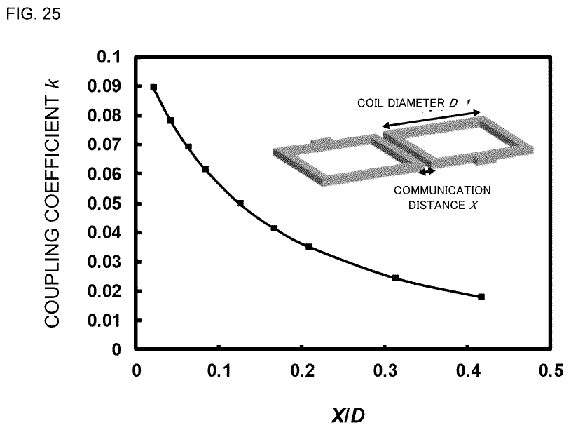

FIG. 25 is a diagram showing a relationship between a communication distance and a coupling coefficient. As shown in FIG. 25, a coupling coefficient k monotonically decreases as a communication distance X increases. In horizontal inductive coupling, the coupling coefficient is 0.023 when a coil diameter D is three times the communication distance X, which is a value of ¼ or less. Here, considering a case where the coil diameter is 5 mm and the communication distance is 800 μm, then the coupling coefficient is 0.042. That is, a transmitting current of about 3.6 times that of conventional inductively coupled communication is required.

3. Relationship between Coil Misalignment and Coupling Coefficient

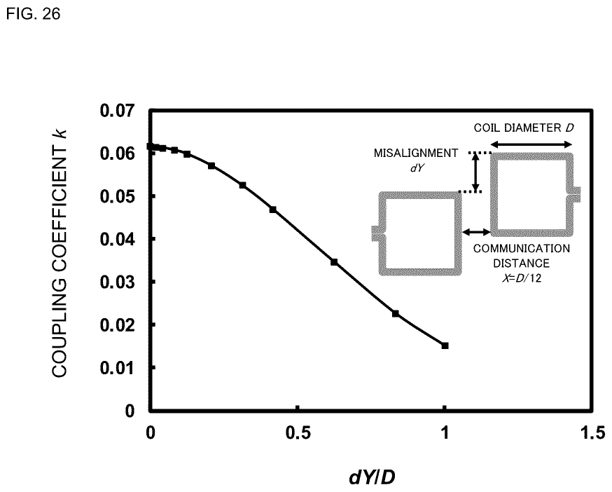

FIG. 26 is a diagram showing a relationship between a coil misalignment and a coupling coefficient. Under a condition that the coil diameter D is 12 times the communication distance X, change of the coupling coefficient k according to a misalignment dY is presented. Even when a position is displaced by about 10% of the coil diameter, the coupling coefficient changes by only 3%. For example, when the coil diameter is 5 mm, the transmitting current may be increased by only 3% even if the position of coil is displaced by 500 μm.

4. Coupling Coefficient when a Plurality of Coils are Arranged

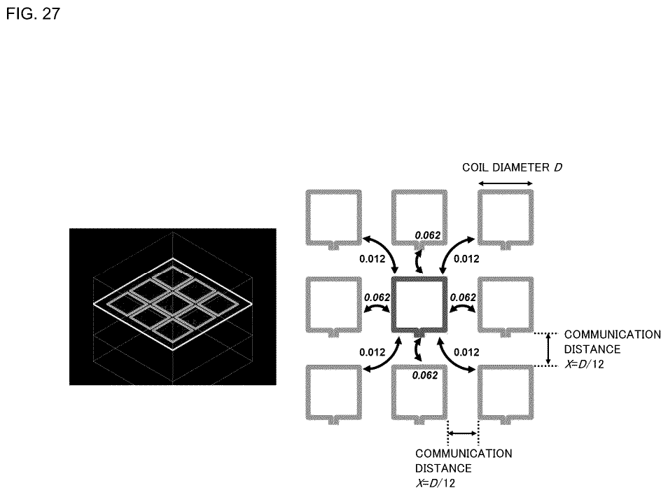

FIG. 27 is a diagram showing a coupling coefficient when a plurality of coils are arranged. As shown in FIG. 27, the coupling coefficient between coils adjacent in diagonal direction is about 20% of the coupling coefficient between coils adjacent in vertical and horizontal directions.

### 5. Circuit Simulation

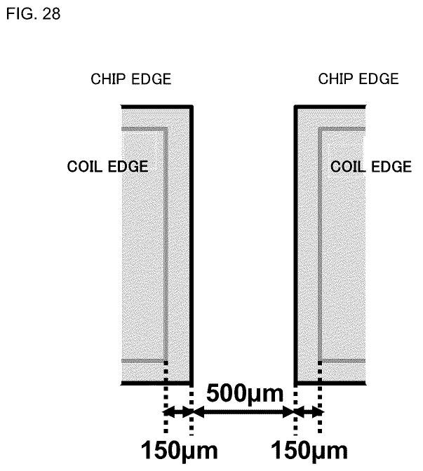

A simulation of the transmitting/receiving core circuit is created, and power consumption or the like is investigated. A 45 nm CMOS process is assumed as a manufacturing process, and the coil diameter is investigated at 5 mm. The communication distance is 0.8 mm. FIG. 28 is a diagram for illustrating the communication distance.

### 6. Simulation Waveform of Transmitting/Receiving Core Circuit

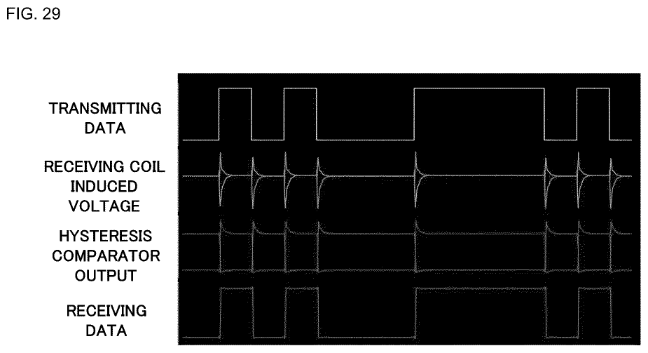

FIG. 29 is a diagram showing an example of a simulation waveform of transmitting/receiving core circuit. A voltage is generated in the receiving coil according to transition of input transmitting data, and original data is restored by the receiving circuit.

### 7. Performance of Transmitting/receiving Core Circuit

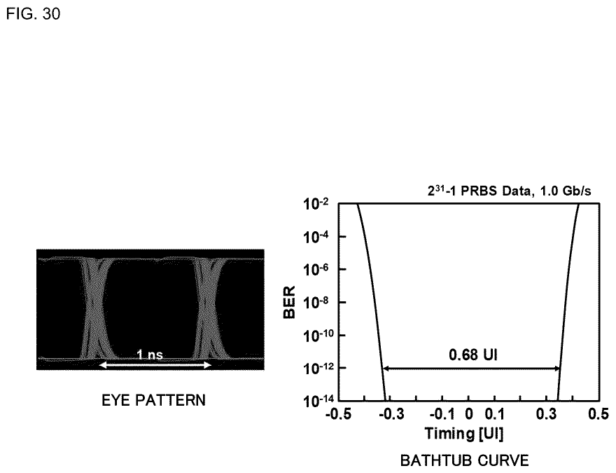

FIG. 30 is a diagram showing an eye pattern and a bathtub curve when a 1.0 Gb/s PRBS-31 signal is input. A timing margin of the designed transmitting/receiving core circuit at BER 10-12 is 0.68 UI, and it is confirmed that the circuit operates with a sufficient margin. Further, power consumption of the transmitting/receiving core circuit is 11.1 mw when the communication distance is 0.8 mm and 6.41 mW when the communication distance is 0.5 mm.

The present invention may be provided in each of the following aspects.

In the information processing apparatus, the plurality of chips are horizontally integrated on a substrate, and the substrate is a variable shape member.

In the information processing apparatus, the variable shape member is a flexible substrate.

In the information processing apparatus, the variable shape member is made of a plastic.

In the information processing apparatus, the variable shape member is made of a fiber.

In the information processing apparatus, the transmitting coil and the receiving coil are formed at substantially same position on each of the plurality of chips.

In the information processing apparatus, the transmitting coil and the receiving coil are formed on different layers of the chip.

In the information processing apparatus, an opening area of the transmitting coil and an opening area of the receiving coil are 80% or more of an area of the chip.

In the information processing apparatus, a seal ring is formed on each of the plurality of chips, and a part of the seal ring is divided.

In the information processing apparatus, a thickness of the seal ring is 2 μm or less.

In the information processing apparatus, a power ring is formed on each of the plurality of chips, and when a coil diameter of the transmitting coil and the receiving coil is approximately 1 mm, a distance between the transmitting coil and the receiving coil and the power ring is 150 μm or more.

In the information processing apparatus, one of the plurality of chips is a CPU (Central Processing Unit).

In the information processing apparatus, one of the plurality of chips is a memory.

In the information processing apparatus, a hardware configuring the information processing apparatus £ is configured of one or more chips among the plurality of chips.

In the information processing apparatus, the hardware is a CPU (Central Processing Unit).

Of course, the above aspects are not intended to limit the present invention.

Further, the above-mentioned embodiments and modifications may be implemented in any combination.

Finally, various embodiments of the present invention have been described, but these are presented as examples and are not intended to limit the scope of the invention. The novel embodiment can be implemented in various other forms, and various omissions, replacements, and changes can be made without departing from the abstract of the invention. The embodiment and its modifications are included in the scope and abstract of the invention and are included in the scope of the invention described in the claims and the equivalent scope thereof.

1. A chip, comprising:
a first coil; and
at least one of a core circuit, a network interface and a transmitting/receiving circuit formed inside the first coil,
wherein the first coil is at least one of a transmitting coil and a receiving coil,
the first coil performs wireless connection utilizing inductive coupling generated between the first coil and a second coil formed on a second chip, and
a coil diameter of the first coil is longer than a communication distance of the wireless connection.

2. The chip according to claim 1, wherein
a relative angle between the first coil and the second coil formed on the second chip is oblique or changeable.

3. The chip according to claim 1, wherein
the second coil is vertically displaced relative to the first coil.

4. The chip according to claim 1, wherein
the second coil is one of horizontally adjacent and obliquely adjacent to the first coil.

5. The chip according to claim 1, wherein
the first coil is formed of an internal wiring of the chip.

6. The chip according to claim 5, wherein
the first coil is formed as both:
the transmitting coil; and
the receiving coil, and
the transmitting coil and the receiving coil are formed on different layers of the chip.

7. The chip according to claim 1, comprising:
the core circuit; and
the transmitting/receiving circuit,
wherein the transmitting/receiving circuit serializes a parallel signal sent from the core circuit into a serialized signal, and burst transfers the serialized signal.

8. The chip according to claim 7, wherein
the transmitting/receiving circuit includes an H-Bridge, a SerDes or a CDR circuit.

9. The chip according to claim 1, wherein
the transmitting/receiving circuit includes a collision detection circuit.

10. The chip according to claim 9, wherein
when a collision of data occurs between the chip and the second chip, the collision detection circuit retransmits the data.

11. The chip according to claim 1, wherein
the transmitting/receiving circuit includes an inverter or a hysteresis comparator.

12. The chip according to claim 1, comprising:
a seal ring outside the first coil; and
a power ring inside the first coil,
wherein a distance between the first coil and the seal ring is shorter than a distance between the first coil and the power ring.

13. An information processing device comprising:
a plurality of chips, each of the plurality of chips being the chip according to claim 1,
wherein the plurality of chips perform wireless connection utilizing inductive coupling generated between coils formed on each of the chips.

14. The information processing device according to claim 13, comprising:
a deformable substrate on which the plurality of chips are provided.

15. The information processing device according to claim 13, wherein
a relative angle between the coils formed on the chips performing wireless connection utilizing inductive coupling is oblique or changeable, and
the plurality of chips are arranged relative to one another so as to extend in a horizontal direction.

16. A method of replacing one chip of a plurality of chips each having a first coil formed thereon, wherein:
the one chip includes at least one of a core circuit, a network interface, and a transceiver circuit formed inside the first coil,
the first coil is at least one of a transmission coil and a reception coil,
the first coil performs wireless connection utilizing inductive coupling generated between the first coil and a second coil formed on a second chip in a horizontal direction relative to the first coil,
a coil diameter of the first coil is longer than a communication distance of the wireless connection, and
the plurality of chips are provided on a substrate.
